(19) United States
(12) Patent Application Publication
(10) Pub. No.: US 2024/0193780 A1
(43) Pub. Date: Jun. 13, 2024

(54) SYSTEMS AND METHODS FOR MONITORING A TOOTH WHITENING REGIMEN

(71) Applicant: Get-Grin Inc., Airmont, NY (US)

(72) Inventors: Adam Benjamin SCHULHOF, New City, NY (US); Alon Luis LIPNIK, Tel Aviv (IL); Pamela Sharon OREN-ARTZI, Airmont, NY (US); Yarden EILAT-BLOCH, Haifa (IL)

(21) Appl. No.: 18/585,568

(22) Filed: Feb. 23, 2024

Related U.S. Application Data
(63) Continuation of application No. PCT/US22/41426, filed on Aug. 24, 2022.
(60) Provisional application No. 63/236,697, filed on Aug. 25, 2021.

(51) Int. Cl. G06T 7/00

(52) U.S. Cl. CPC G06T 7/0016; G06T 2207/10024; G06T 2207/10064; G06T 2207/30036

(57) ABSTRACT

Described herein are systems and methods for monitoring progress or predicting an outcome of a tooth whitening regimen, including a method to monitor progress or predict an outcome of a tooth whitening regimen, comprising: (a) providing an adapter comprising a viewing channel configured to define a field of view of an intraoral region of a subject's mouth, wherein one or more teeth are visible in the field of view of the subject's mouth; (b) providing a color reference target comprising one or more color samples, wherein the color reference target appears in the field of view of the subject's mouth, and wherein each of the one or more color samples is associated with a reference color or shade; (c) using the color reference target to identify the color or shade of the one or more teeth; and (d) predicting the outcome of the tooth whitening regimen based on the identified color or shade of the one or more teeth and, optionally, one or more properties of the one or more teeth.

### CROSS-REFERENCE TO RELATED APPLICATIONS

The present application is a continuation of International Application No. PCT/US22/41426 filed Aug. 24, 2022, which claims the benefit of U.S. Provisional Application Ser. No. 63/236,697 filed Aug. 25, 2021, each of which is expressly incorporated by reference herein in its entirety.

### TECHNICAL FIELD

The present invention, in at least some embodiments, relates to a method and a system for dental imaging, and more specifically systems and methods for monitoring the progress or predicting an outcome of a tooth whitening regimen.

### BACKGROUND

Teeth whitening regimens are becoming increasingly common. Such treatments can be performed in a clinic by a dental professional or completed at home using whitening kits that can be purchased at a store. Teeth whitening can be performed using bleach trays, white strips, whitening toothpaste, or by a variety of treatments or and materials. The progress of a tooth whitening regimen can be monitored by evaluated teeth shades at various points in time before, during, and after the treatments. Additionally, predicting the outcome of a tooth whitening regimen can affect dramatically the successes or the visibility of such treatments.

### SUMMARY

Recognized herein is a need for remote dental monitoring solutions that allow users to predict the outcome of or monitor a tooth whitening regimen, without requiring a dental professional to be physically present with the user. Not all human teeth react the same way to some whitening process. The way a tooth responds to a whitening treatment may depend on a number of different factors, including the baseline color or shade of the tooth, the opacity of the tooth, the thickness of the dentin, the presence of dental implants, etc. The systems and methods described herein provide a way to predict the outcome of a tooth whitening regimen and use such predictions to personalize and optimize the whitening process to an individual user.

The present disclosure provides methods and systems to monitor progress or predict an outcome of a tooth whitening regimen. As used herein, intraoral imaging may refer to the acquisition of one or more intraoral videos and/or intraoral images. The methods and systems disclosed herein may provide a convenient solution and user experience for whitening process users to capture one or more intraoral videos or images using a mobile device such as a smartphone. The methods and systems disclosed herein may provide dentists, orthodontists and dental consultants with a detailed analysis of the user's dental condition and whitening progress based on one or more dental scans captured remotely by the user.

In an aspect, provided herein, is a method to monitor progress or predict an outcome of a tooth whitening regimen, comprising: (a) providing an adapter comprising a viewing channel configured to define a field of view of an intraoral region of a subject's mouth, wherein one or more teeth are visible in the field of view of the subject's mouth: (b) providing a color reference target comprising one or more color samples, wherein the color reference target appears in the field of view of the subject's mouth, and wherein each of the one or more color samples is associated with a reference color or shade: (c) using the color reference target to identify the color or shade of the one or more teeth: and (d) predicting the outcome of the tooth whitening regimen based on the identified color or shade of the one or more teeth and, optionally, one or more properties of the one or more teeth.

In some cases, the adapter comprises a flange that is configured to couple the adapter to the subject's mouth. In some cases, the adapter is configured to block environment light from the field of view of the intraoral region of the subject's mouth. In some cases, the adapter further comprises a light source, and wherein the light source is configured to illuminate at least part of the viewing channel. In some cases, the adapter is configured to couple to a camera configured to capture images or videos of the subject's mouth, wherein the captured images or videos comprise the one or more teeth of the subject. In some cases, the camera is part of a mobile device.

In some cases, the adapter is configured to be moved in the subject's mouth to adjust the field of view of the intraoral region of the subject's mouth. In some cases, the one or more color samples are based on a color quantification scheme. In some cases, the color quantification scheme is the Munsell color system. In some cases, at least one of the one or more color samples is chosen from a color in a ColorChecker calibration target. In some cases, at least one of the one or more color samples is a color of a natural tooth. In some cases, at least one of the one or more color samples is a shade of a natural tooth under light at a wavelength of 390 nm to 450 nm. In some cases, at least one of the one or more color samples is a shade of a natural tooth under fluorescent light.

In some cases, a processing unit is used to identify the color or shade of the one or more teeth, and wherein a mobile device comprises the processing unit. In some cases, the mobile device is a smartphone. In some cases, identifying the color or shade of the one or more teeth comprises using the reference color or shade of the one or more color samples to identify the color of the one or more teeth in the captured videos or images. In some cases, a property of the one or more visual properties comprises a reflection of light from the one or more teeth. In some cases, the reflection of light is determined under light at a wavelength of 390 to 450 nm. In some cases, the reflection of light is determined under fluorescent light. In some cases, a property of the one or more properties comprises an opacity of the one or more teeth. In some cases, the opacity of the one or more teeth is determined under light at a wavelength of 390 to 450 nm. In some cases, the opacity of the one or more teeth is determined under fluorescent light. In some cases, a property of the one or more properties comprises a thickness of the dentin of the one or more teeth. In some cases, the thickness of the dentin is determined under light at a wavelength of 100 to 400 nm. In some cases, the thickness of the dentin is determined under ultraviolet light. In some cases, a property of the one or more properties comprises a classification of the tooth as natural or artificial. In some cases, the classification of the tooth as natural or artificial is determined under light at a wavelength of 100 to 400 nm. In some cases, the classification of the tooth as natural or artificial is determined under ultraviolet light. In some cases, the color or shade of the one or more teeth is the color or shade of the one or more teeth prior to the subject undergoing the tooth whitening treatment. In some cases, the predicted outcome comprises a predicted color or shade of the one or more teeth subsequent to the tooth whitening regimen.

In some cases, the further comprises generating an image of the mouth of the subject with the predicted color or shade of the one or more teeth. In some cases, the method further comprises subsequent to (d), comparing the predicted outcome of the tooth whitening regimen with an actual outcome of the tooth whitening regimen. In some cases, the comparing comprises comparing the predicted color or shade of the one or more teeth with an actual color or shade of the one or more teeth after the subject has undergone the tooth whitening regimen. In some cases, the comparison determines if the subject is adhering to the tooth whitening regimen. In some cases, the predicting in (d) comprises determining if the subject is a candidate for the teeth whitening treatment.

In another aspect, provided herein, is a kit for monitoring progress or predicting an outcome of a tooth whitening regimen, comprising: (a) an adapter comprising a viewing channel configured to define a field of view of an intraoral region of a subject's mouth, wherein one or more teeth are visible in the field of view of the subject's mouth: (b) a color reference target comprising one or more color samples, wherein the color reference target appears in the field of view of the subject's mouth, and wherein each of the one or more color samples is associated with a reference color or shade: and (c) a mobile application configured to use the color reference target to identify the color or shade of the one or more teeth and predict the outcome of the tooth whitening regimen based on the identified color or shade of the one or more teeth and, optionally, one or more properties of the one or more teeth.

In some cases, the adapter comprises a flange that is configured to couple the adapter to the subject's mouth. In some cases, the adapter is configured to block environment light from the field of view of the intraoral region of the subject's mouth. In some cases, the adapter further comprises a light source, and wherein the light source is configured to illuminate at least part of the viewing channel. In some cases, the adapter is configured to couple to a camera configured to capture images or videos of the subject's mouth, wherein the captured images or videos comprise the one or more teeth of the subject. In some cases, the camera is part of a mobile device. In some cases, the adapter is configured to be moved in the subject's mouth to adjust the field of view of the intraoral region of the subject's mouth.

In some cases, the one or more color samples are based on a color quantification scheme. In some cases, the color quantification scheme is the Munsell color system. In some cases, at least one of the one or more color samples is chosen from a color in a ColorChecker calibration target. In some cases, at least one of the one or more color samples is a color of a natural tooth. In some cases, at least one of the one or more color samples is a shade of a natural tooth under light at a wavelength of 390 nm to 450 nm. In some cases, at least one of the one or more color samples is a shade of a natural tooth under fluorescent light.

In some cases, a processing unit is used to identify the color or shade of the one or more teeth, and wherein a mobile device comprises the processing unit. In some cases, the mobile device is a smartphone.

In some cases, identifying the color or shade of the one or more teeth comprises using the reference color or shade of the one or more color samples to identify the color of the one or more teeth in the captured videos or images. In some cases, a property of the one or more properties comprises the reflection of light from the one or more teeth. In some cases, the reflection of light is determined under light at a wavelength of 390 to 450 nm. In some cases, the reflection of light is determined under fluorescent light. In some cases, a property of the one or more properties comprises the opacity of the one or more teeth. In some cases, the opacity of the one or more teeth is determined under light at a wavelength of 390 to 450 nm.

In some cases, the opacity of the one or more teeth is determined under fluorescent light. In some cases, a property of the one or more properties comprises the thickness of the dentin of the one or more teeth. In some cases, the thickness of the dentin is determined under light at a wavelength of 100 to 400 nm. In some cases, the thickness of the dentin is determined under ultraviolet light. In some cases, a property of the one or more properties comprises a classification of the tooth as natural or artificial. In some cases, the classification of the tooth as natural or artificial is determined under light at a wavelength of 100 to 400 nm. In some cases, the classification of the tooth as natural or artificial is determined under ultraviolet light.

In some cases, the color or shade of the one or more teeth is the color or shade of the one or more teeth prior to the subject undergoing the tooth whitening treatment. In some cases, the predicted outcome comprises a predicted color or shade of the one or more teeth subsequent to the tooth whitening regimen. In some cases, the further comprises generating an image of the mouth of the subject with the predicted color or shade of the one or more teeth. In some cases, the predicted outcome of the tooth whitening regimen is compared with an actual outcome of the tooth whitening regimen. In some cases, the comparing comprises comparing the predicted color or shade of the one or more teeth with an actual color or shade of the one or more teeth after the subject has undergone the tooth whitening regimen. In some cases, the comparison determines if the subject is adhering to the tooth whitening regimen. In some cases, the predicted outcome comprises determining if the subject is a candidate for the teeth whitening treatment.

As used herein, the term “teeth whitening” refers to any process of lightening the color of human teeth. Teeth whitening can also be referred to as tooth whitening, teethbleaching, or tooth bleaching.

As used herein, the term “teeth whitening index” refers to a predictive measurement tool used to predict or assess an outcome of a tooth whitening regimen

As used herein, the term “dental scan” refers to a video or an image frame from a video or an image capture of the intraoral perspective of the teeth arch or of a tooth.

As used herein, the term “color reference target” refers an object with at least three color samples that have known HUE, VALUE and CHROMA according to Munsell Notation, or known Red, Green and Blue values according to sRGB notation and can be used for color calibration.

As used herein, the term “environmental light” refers to any light that originates from outside of a disclosed adapter or mobile device.

As used herein, the term “natural tooth” refers to a tooth that has grown in a subject's mouth or an implant from a human source. As used herein, a natural tooth is a tooth that has enamel or equivalent in the outer layer and can react to whitening process by lightening in shade.

As used herein, the term “quantitative light-induced fluorescence” (QLF) or fluorescent light refers to an imaging technique that can be use in dental imaging. QLF exposes an intraoral region of a subject to light at a wavelength of 390 nm to 450 nm. In some cases, an image or video of the exposed tooth or teeth is captured with a mobile device camera.

As used herein, the term “ColorChecker” refers to a color calibration target consisting of a framed arrangement of twenty-four squares of colored samples. A ColorChecker can be used for color calibrations.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

In order to understand the systems and methods described herein and to see how they may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1A schematically illustrates optical color reference targets, in accordance with some embodiments.

FIG. 1B schematically illustrates an intraoral image captured using the methods and systems provided herein, in accordance with some embodiments.

FIG. 1C schematically illustrates optical color reference targets, in accordance with some embodiments.

FIG. 1D schematically illustrates an intraoral image captured using the methods and systems provided herein, in accordance with some embodiments.

FIGS. 2A-2F schematically illustrate an example intraoral adapter to which a mobile device can be coupled to perform a dental scan, in accordance with some embodiments.

FIG. 3 schematically illustrates a method for monitoring progress or predicting an outcome of a tooth whitening regimen

FIG. 4 schematically illustrates a computer system that is programmed or otherwise configured to implement methods provided herein.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the methods and systems described herein. It should be understood that various alternatives to the embodiments of the methods and systems described herein may be employed.

The term “real-time,” as used herein, generally refers to a simultaneous or substantially simultaneous occurrence of a first event or action with respect to an occurrence of a second event or action. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than.” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “a,” “an,” and “the,” as used herein, generally refer to singular and plural references unless the context clearly dictates otherwise.

### Overview

The present disclosure provides methods and systems for whitening process assessment and or monitoring. As used herein, intraoral imaging may refer to the acquisition of one or more intraoral videos and/or intraoral images. The methods and systems disclosed herein may provide a convenient solution and user experience for whitening process users to capture one or more intraoral videos or images using a mobile device such as a smartphone. The methods and systems disclosed herein may provide dentists, orthodontists and dental consultants with a detailed analysis of the user's dental condition based on one or more dental scans captured remotely by the user.

The methods and systems of the present disclosure may also be used to provide dental users with a remote dental scanning without requiring assistance from a dentist or a dental assistant. The method and system disclosed herein may permit dentists to view high quality videos or images of a user's teeth so that the dentist can monitor the user's teeth or treatment progress without being physically present and without having to provide personalized or customized instructions for how to acquire the intraoral images or videos.

In an aspect, the present disclosure provides methods and systems for a real color dental scan. The methods and systems of the present disclosure may be implemented using a software application that is configured to enable a dental user to capture videos and/or images of intraoral regions. The software application may be used by a user or a subject (e.g., a dental user) in conjunction with a mobile device to remotely monitor a dental anatomy or a dental condition of the subject. A dental anatomy may comprise one or more dental structures of the user, including one or more tooth structures or dental arches of the subject. A dental anatomy may comprise identify tooth or teeth color and/or identify tooth or teeth shade. In some cases, the dental condition may comprise the color or a structure or a change in the color or structure and can be followed by whitening process fitment assessment.

The dental scan may be used to enable remote dental monitoring, reference or consulting. As used herein, remote monitoring may refer to monitoring that is performed at one or more locations remote from the user. For example, a dentist or a medical specialist may monitor the dental anatomy or dental condition in a first location that is different than a second location where the user is located. The first location and the second location may be separated by a distance spanning at least 1 meter, 1 kilometer, 10 kilometers, 100 kilometers, 1000 kilometers, or more.

The remote monitoring may be performed by assessing a dental anatomy or a dental condition of the subject using one or more dental scan captured by the subject when the user is located remotely from the dentist or a dental office. In some cases, the remote monitoring may be performed in real-time such that a dentist is able to assess the dental anatomy or the dental condition when a subject uses a mobile device to acquire one or more dental scan of one or more intraoral regions in the user's mouth. The remote monitoring may be performed using equipment, hardware, and/or software that is not physically located at a dental office.

The software application for dental scan may be configured to run on a mobile device. The mobile device may comprise a smartphone, a tablet, a laptop, or any suitable device that may be used by a user to capture one or more dental scan. The software application may be installed on a mobile device of a user. The software application may be a user-side software application.

In some cases, the user-side software application may be used in a compatible manner with a practitioner-side software application that is accessible by a caregiver. The user-side software application and the practitioner-side software application may enable real-time communication and sharing of dental scan, or data between one or more users and one or more caregivers. The one or more caregivers may comprise, for example, a dentist, an orthodontist, an oral surgeon, individuals having one or more dental specialties, or a dental staff practitioner.

### Monitoring the Progress of a Teeth Whitening Regimen

In an aspect, the present disclosure provides a method to assess a teeth whitening process, comprising providing an adapter, providing a mobile device, performing a dental scan using the mobile device coupled to the adapter: and generating a dental scan analysis comprising teeth shades index and teeth whitening index. Wherein the adapter comprises a viewing channel between a proximal portion and a distal portion and a color reference target of at least three color samples: and the mobile device comprises a camera and ability to capture videos or images.

In some embodiments the adapter comprises a flange that is sized and shaped to couple the adapter to a user mouth, and wherein the adapter placed in the user mouth blocks environment light.

In some embodiments the adapter further comprises a light source and wherein the light source can illuminate the viewing channel. In some embodiment the light source illuminates the viewing channel with 400 nm-to 700 nm wavelength light. In some embodiment the light source illuminates the viewing channel with 390 nm-to 450 nm wavelength light. In some embodiments the light source can fit QLF. In some embodiments the light source can be describe at color temperature and it is measured in degree of Kelvin, in some preferred embodiments the light source temperature is in the range of 1000k to 10,000k. In some preferred embodiments the light source is control from the mobile device. In some preferred embodiments the light source is powered from the mobile device.

In some embodiments the adapter can be moved in the user's mouth.

In some embodiments the color samples are chosen from Munsell color system.

In some preferred embodiments at least one of the color samples is chosen from ColorChecker colors.

TABLE 1
Optional color samples

| | | | | Munsell Notation | |
|---|---|---|---|---|---|
| | sRGB | | | Hue | |
| color | Red | Green | Blue | Value/Chrome | |
| dark skin | 115 | 82 | 68 | 3 YR | 3.7/3.2 |
| Light skin | 194 | 150 | 130 | 2.2 YR | 6.47/4.1 |
| Blue sky | 98 | 122 | 157 | 4.3 PB | 4.95/5.5 |
| Foliage | 87 | 108 | 67 | 6.7 GY | 4.2/4.1 |
| Blue flower | 133 | 128 | 177 | 9.7 PB | 5.47/6.7 |
| Bluish green | 103 | 189 | 170 | 2.5 BG | 7/6 |
| Orange | 214 | 126 | 44 | 5 YR | 6/11 |
| Purplish blue | 80 | 91 | 166 | 7.5 PB | 4/10.7 |
| Moderate red | 193 | 90 | 99 | 2.5 R | 5/10 |
| Purple | 94 | 60 | 108 | 5 P | 3/7 |
| Yellow green | 157 | 188 | 64 | 5 GY | 7.1/9.1 |
| Ornge yellow | 224 | 163 | 46 | 10 YR | 7/10.5 |
| Blue | 56 | 61 | 150 | 7.5 PB | 2.9/12.7 |
| green | 70 | 148 | 73 | 0.25 G | 5.4/8.65 |
| Red | 175 | 54 | 60 | 5 R | 4/12 |
| yellow | 231 | 199 | 31 | 5 Y | 8/11.1 |
| Magenta | 187 | 86 | 149 | 2.5 RP | 5/12 |
| Cyan | 8 | 133 | 161 | 5 B | 5/8 |
| White | 243 | 243 | 242 | N | 9.5/ |
| Neutral 8 | 200 | 200 | 200 | N | 8/ |
| Neutral 6.5 | 160 | 160 | 160 | N | 6.5/ |
| Neutral 5 | 122 | 122 | 121 | N | 5/ |
| Neutral 3.5 | 85 | 85 | 85 | N | 3.5/ |
| Black | 52 | 52 | 52 | N | 2/ |

In some preferred embodiments at least one of the color samples is color of natural tooth.

TABLE 2
Teeth shade color samples

| | |
|---|---|
| | Munsell Notation Hue |
| Shade | Value/Chrome |

| | | |
|---|---|---|
| A1 | 4.5 | 7.8/1.7 |
| A2 | 2.4 | 7.45/2.6 |
| A3 | 1.3 | 7.4/2.9 |
| A 3.5 | 1.6 | 7.05/3.2 |
| A4 | 1.6 | 6.7/3.1 |
| B1 | 5.1 | 7.75/1.6 |
| B2 | 4.3 | 7.5/2.2 |
| B3 | 2.3 | 7.25/3.2 |
| B4 | 2.4 | 7.0/3.2 |
| C1 | 4.3 | 7.3/1.6 |
| C2 | 2.8 | 6.9/2.3 |
| C3 | 2.6 | 6.7/2.3 |
| C4 | 1.6 | 6.3/2.9 |
| D2 | 3.0 | 7.35/1.8 |
| D3 | 1.8 | 7.1/2.3 |
| D4 | 3.7 | 7.05/2.4 |

In some preferred embodiments at least one of the color samples is correlated to tooth shades captured at 390 nm-to 450 nm wavelength light exposure or fluorescent light. In some preferred embodiments the color reference target of at least four color samples, at least five color samples, at least six color samples, at least seven color samples, at least eight color samples, at least nine color samples or at least ten color samples.

In some cases, the color reference target can be used to identify the color or shade of the one or more teeth by the mobile device. In some cases, the color reference target provides color samples that match all colors present in an image or video of the intraoral region of a subject, and the identification is performed by comparing the color samples to the images or video until a match is identified.

In some cases, the color reference target provides multiple color samples that are in the vicinity of or similar to the color of the target oral landmark (i.e., teeth or gums), and the identification is performed by comparing the color samples to the images or video in order to calibrate the colors of the image and then measuring the calibrated color on the teeth in the image or video.

In some embodiments the mobile device comprises a processing unit, and wherein the processing unit transforms the shade of at least part of at least tooth according to the color reference target.

In some embodiments the mobile device is a smartphone.

In some embodiments the dental scan is an intraoral video or image.

In some embodiments the dental scan captures at least one tooth.

In some embodiments the generating includes sampling the color reference target, creating a mapping from the original capture colors to colors according to a chosen illuminant, and transforming the original capture pixel values according to the mapping.

In some embodiments the original capture includes at least part of a tooth.

In some embodiments the transform color of at least part of at least one tooth is shade analyzed and index.

In some embodiments the transform color of at least part of at least one tooth is compared to natural tooth colors (for example table 2) and can get a score wherein the score is equivalent to the shade resemble. In some embodiments the transform color of at least part of at least one tooth is compared to table of white colors at different color temperatures and can get a score wherein the score is equivalent to the white resembles.

In some embodiments the transform tooth shade score and/or the transform tooth white score assembles the tooth index.

In some embodiments the transform color of at least part of at least one tooth is material analyzed and index.

In some embodiments the transform color of at least part of at least one tooth is compared to tooth shades captured at 390 nm-to 450 nm wavelength light exposure to quantify the whitening process capable materials content in the tooth.

In some preferred embodiments the material is enamel.

In some preferred embodiment the whitening process capable materials content in the tooth or part of a tooth or layer thickness are score and index.

In some embodiments the generating includes presenting at least one tooth shade index and tooth whitening index.

In some embodiments the generating includes presenting include all captured teeth tooth shade index and tooth whitening index.

In some embodiments the method further comprising providing a user open mouth image and wherein the generating include presenting the visible teeth tooth shade index and tooth whitening index in the image.

In some embodiments the method further comprising providing a whitening process data and wherein the generating include calculating teeth predicted tooth shade index and predicted tooth whitening index.

In some embodiments the generating includes presenting the teeth predicted tooth shade.

In some preferred embodiments the method further comprising providing a user open mouth image and wherein the generating include presenting the visible teeth predicted tooth shade.

In some embodiments the method further comprising providing a different user data and wherein the generating include calculating teeth predicted tooth shade index and predicted tooth whitening index.

In some embodiments the different user data includes at least one original tooth shade index and tooth whitening index and at least one final tooth shade and the whitening process used.

### Kit for Monitoring the Progress or Predicting an Outcome of a Tooth Whitening Regimen

In additional aspect, the present disclosure provides a teeth whitening supporting kit, comprising an adapter with a viewing channel between a proximal portion and a distal portion and a color reference target of at least three color samples, a flange that is sized and shaped to couple the adapter to a user mouth, and wherein the adapter placed in the user mouth blocks environment light: and a mobile device comprises a camera and ability to capture videos or images.

In some embodiments the adapter further comprises a light source and wherein the light source can illuminate the viewing channel.

In some embodiments the adapter further comprises a light source and wherein the light source can illuminate at 390 nm-to 450 nm wavelength light.

In some embodiments the adapter can be moved in the user's mouth.

In some embodiments the color samples are chosen from Munsell color system.

In some preferred embodiments at least one of the color samples is chosen from ColorChecker colors.

In some preferred embodiments at least one of the color samples is color of natural tooth.

In some preferred embodiments at least one of the color samples is correlated to tooth shades captured at 390 nm-to 450 nm wavelength light exposure or fluorescent light.

In some embodiments the mobile device can be coupled to the adapter, and the adapter can be placed into user mouth and conduct a dental scan.

In some embodiments the dental scan is an intraoral video or image.

In some embodiments the dental scan captures at least one tooth.

In some embodiments the mobile device comprises a processing unit, and wherein the processing unit transforms a shade of at least part of at least tooth according to the color reference target.

In some embodiments the mobile device coupled to the adapter can be used for a user dental scan to generate a dental scan analysis comprising teeth shades index and teeth whitening index.

In some embodiments the mobile device is a smartphone.

In some embodiments the generate a dental scan includes sample of the color reference target, create a mapping from the original capture colors to colors according to a chosen illuminant, and transform the original capture pixel values according to the mapping.

In some preferred embodiments the original capture includes at least part of a tooth.

In some embodiments the transform color of at least part of at least one tooth is shade analyzed and index.

In some embodiments the transform color of at least part of at least one tooth is material analyzed and index.

In some preferred embodiments the material is enamel.

In some embodiments the mobile device includes a screen and at least one tooth shade index and tooth whitening index can be presented on the screen.

In some embodiments the supporting kit further comprising providing a whitening process data and wherein the mobile device can calculate teeth predicted tooth shade index and predicted tooth whitening index.

In some embodiments the mobile device includes a screen and can present at least one of the teeth predicted tooth shade.

In some embodiments the dental scan analysis comprising teeth shades index and teeth whitening index is used to suggest a tooth whitening process.

In some embodiments the dental scan analysis comprising teeth shades index and teeth whitening index is used to produce a tooth whitening process.

In some embodiments the dental scan analysis comprising teeth shades index and teeth whitening index is used to produce a tooth whitening material.

In some embodiments the produce a tooth whitening material is fitted to a user.

In some embodiments the supporting kit is used to monitor tooth whitening process.

In some embodiments the supporting kit is used to analyzed the effectiveness of the tooth whitening process.

In some embodiments the supporting kit is used to assess tooth whitening process.

In some embodiments the supporting kit is used to monitor tooth whitening process.

In some embodiments the supporting kit is used to collect data on tooth whitening processes.

In some embodiments the supporting kit is used to periodically monitor user teeth.

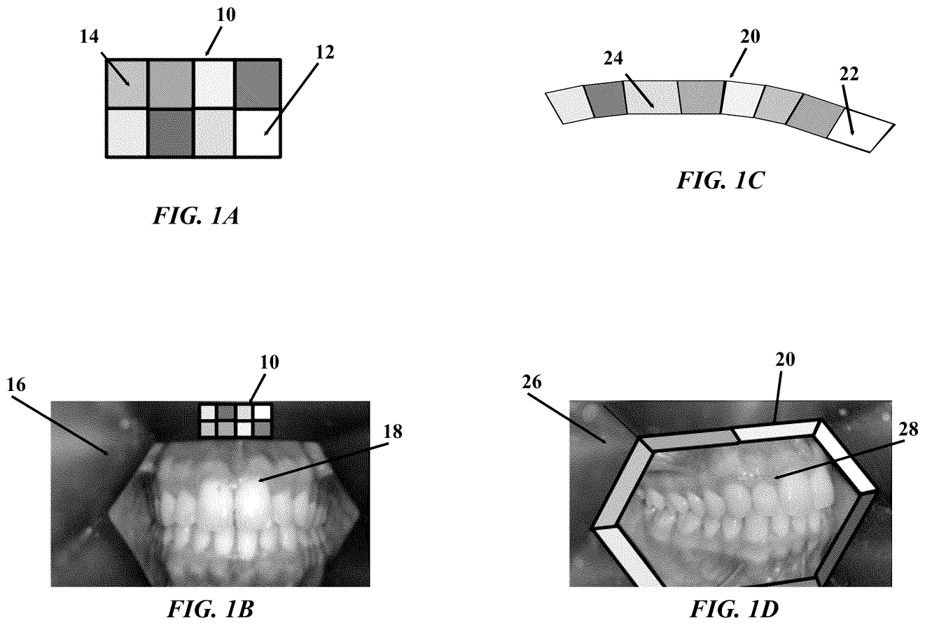

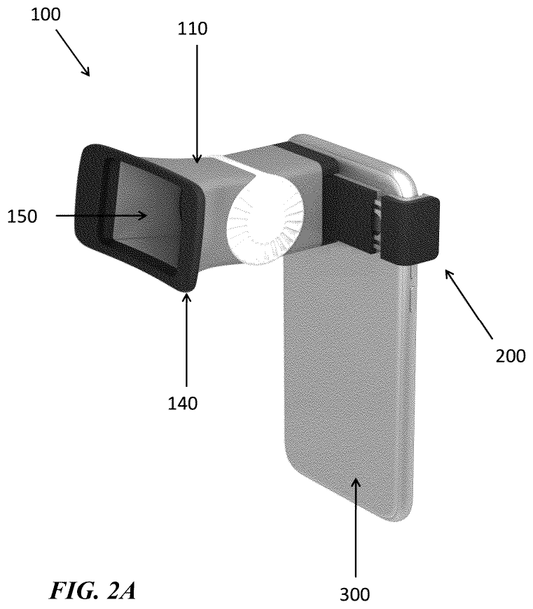

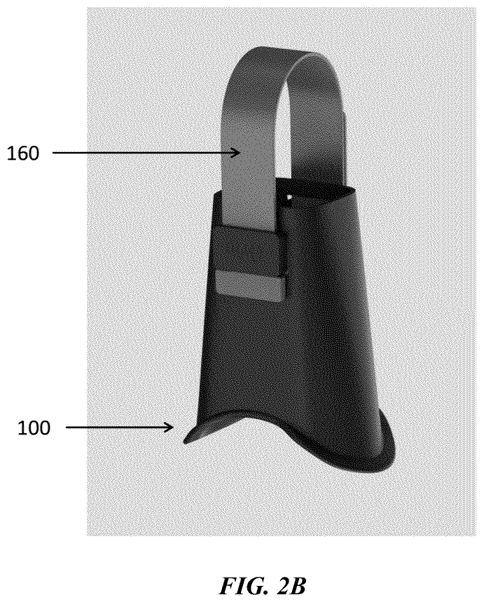

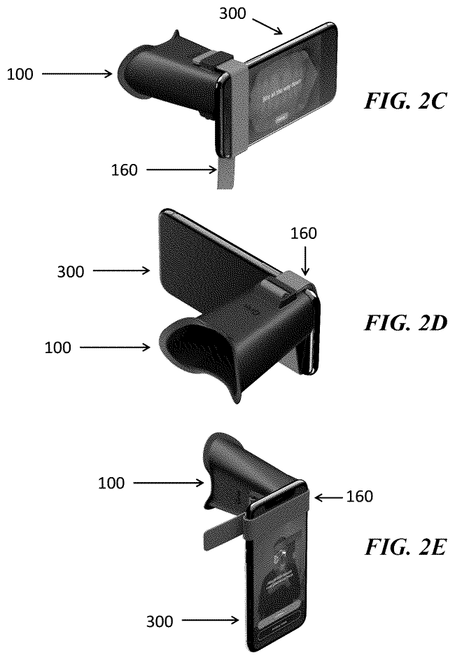

FIG. 1A illustrates an example of color reference target 10 that may be used with the system and methods disclosed herein. The color reference target 10 frame can be made from paper, cardboard, plastic, metal, or any other materials suitable for use as a color sample frame. The color samples, two of which are indicated as 12 and 14, can be made from paper, cardboard, plastic, metal, porcelain, dentin, enamel, or any other materials suitable for use as a color sample. The size of the color reference target can be chosen to facilitate attachment to an intraoral imaging device. In some cases, a color reference target may be fitted or attached to an intraoral or dental scan adapter. The color reference adapter may be a screen that presents color sample that correspond to the intraoral tissue being imaged, and the desired wavelength exposer. In one example, the color reference target has the following color samples:

TABLE 3
Examples of color samples for an intraoral dental scan

| | | | | Munsell Notation | |
|---|---|---|---|---|---|
| | sRGB | | | Hue | |
| color | Red | Green | Blue | Value/Chrome | |
| Light skin | 194 | 150 | 130 | 2.2 YR | 6.47/4.1 |
| Moderate red | 193 | 90 | 99 | 2.5 R | 5/10 |
| Orange yellow | 224 | 163 | 46 | 10 YR | 7/10.5 |
| Red | 175 | 54 | 60 | 5 R | 4/12 |
| Magenta | 187 | 86 | 149 | 2.5 RP | 5/12 |
| White | 243 | 243 | 242 | N | 9.5/ |
| Neutral 6.5 | 160 | 160 | 160 | N | 6.5/ |
| Neutral 3.5 | 85 | 85 | 85 | N | 3.5/ |

In the FIG. 1A the color sample 12 white and color sample 14 moderate red are pointed to for reference.

FIG. 1B illustrates an example view of a color reference target 10 that can be coupled to a dental scan adapter 16 while imaging the intraoral region 18 of a user in accordance with some embodiments of systems and methods described herein.

FIG. 1C illustrates an example of color reference target 20 that may be used with the system and methods disclosed herein. The color reference target frame 20 can be made from paper, cardboard, plastic, or any other suitable material. The color reference target can be folded or deformed to fit into a dental scan adapter as shown in FIG. 1D. In one example, the color reference target has the same color samples as a reference color reference target, like the one shown in FIG. 1A. Additional sets of color samples can be used in the same manner. Color samples may be ordered in any configuration. In FIG. 1C, the color sample 22 white and color sample 24 moderate red are pointed to for reference.

FIG. 1D illustrates an example attachment and view of a color reference target 20 that can be coupled to a dental scan adapter 26 while imaging the intraoral region 28 of a user in accordance with some embodiments of systems and methods described herein.

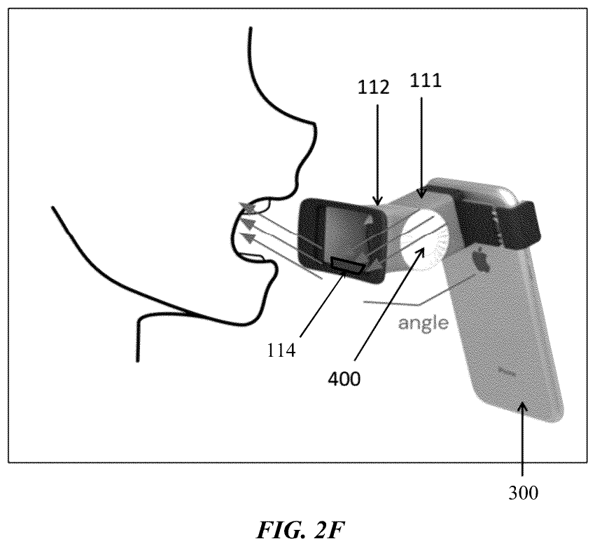

FIG. 2A illustrates an example of an adapter 100 that may be used with the systems and methods disclosed herein. The adapter 100 may comprise an elongated housing 110 with a mounting mechanism 200 and a mobile device 300 coupled to the intraoral adapter 100 via the mounting mechanism 200. The mounting mechanism 200 may be configured to couple the mobile device 300 to the adapter 100 such that a longitudinal axis of a viewing channel 150 of the intraoral adapter 100 is substantially aligned with an optical axis of one or more cameras of the mobile device 300. The mounting mechanism 200 may be configured to mechanically engage with the mobile device 300 or a casing of the mobile device 300. In some embodiments, the mounting mechanism may comprise an elastic band, a clamp, a hook, a magnet, a bracket, or a holder.

The optical axis of the one or more cameras of the mobile device 300 may be aligned with one or more intraoral regions of the subject's mouth when a flange 140 of the elongated housing 110 is positioned between a tooth portion and a gum portion of the subject's mouth. The mobile device may comprise an imaging device (e.g., a camera) that can be configured to capture the one or more intraoral images or videos.

The viewing channel 150 of the elongated housing 110 may be configured to define a field of view of an intraoral region of a subject's mouth. The field of view may be sized and/or shaped to permit one or more cameras of the mobile device 300 to capture one or more videos or images of one or more intraoral regions in a subject's mouth. In some cases, the videos may comprise one or more intraoral images showing a full dental arch of the subject.

The flange 140 may be sized and shaped to couple the adapter to the subject's mouth when the flange 140 is positioned between a gum portion and a tooth portion of the subject's mouth. The adapter 100 may be suspended from the subject's mouth when the flange 140 is positioned between the gum portion and the tooth portion of the subject's mouth. The gum portion and the tooth portion may be in contact with a first side of the flange 140 and a second side of the flange 140 to support a weight of the adapter 100 when the adapter 100 is suspended from the subject's mouth. The flange 140 may be sized and shaped to permit the subject to move the adapter and/or to adjust a position or an orientation of the adapter relative to one or more intraoral regions in the subject's mouth. Adjusting the position or the orientation of the adapter relative to one or more intraoral regions in the subject's mouth may also adjust a position or an orientation of the camera of the mobile device relative to the one or more intraoral regions in the subject's mouth. Adjusting a position or an orientation of the camera of the mobile device relative to the one or more intraoral regions in the subject's mouth may further adjust a relative position and/or a relative orientation of an optical axis of the camera relative to the one or more intraoral regions in the subject's mouth. The flange 140 may remain between the gum portion and the tooth portion of the subject's mouth while the subject moves the adapter around in the subject's mouth. The flange 140 may be sized and shaped to permit the subject to capture one or more intraoral videos or images of a full dental arch of the subject. In any of the embodiments described herein, the flange 140 of the adapter may be configured to be positioned outside the field of view defined by the viewing channel of the adapter.

FIGS. 2B, 2C, 2D, and 2E illustrate another embodiment of an adapter 100 that may be used to capture intraoral videos or images. In some cases, the adapter 100 may comprise an attachment mechanism 160 for coupling a mobile device 300 to the adapter 100. The attachment mechanism 160 may comprise, for example, a strap for securing the mobile device 300 to the adapter 100. The strap may comprise a flexible and/or compliant material, such as silicone. In some cases, the strap may comprise any biocompatible material, or any material that is dishwasher safe. The strap may be adjustable to enable a user to couple various mobile devices having different sizes, shapes, and/or form factors. The adjustability of the strap may provide several advantages, including improved compatibility with different mobile devices having distinct camera configurations, or imaging sensors disposed on different portions or locations on the mobile device.

The method may permit the user to take one or more intraoral images or videos. The intraoral images or videos may be captured while the user is moving the intraoral adapter, or after the user moves the intraoral adapter to a predetermined location.

FIG. 2F illustrates another embodiment of an adapter 100 that may be used to capture intraoral videos or images. In some cases, the adapter 100 may comprise a flexible element 400) that can connect the two viewing channels 111 and 112. The adapter can comprise color reference target 114. The color reference target 114 can be coupled to the viewing channel at any location, In some cases, the color reference target 114 is coupled to the upper inner side, left inner side, right inner side, or lower inner side of the viewing channel 112. In some cases, the adapter 100 is connected to a smartphone 300. The adapter 100 can be placed in a user mouth.

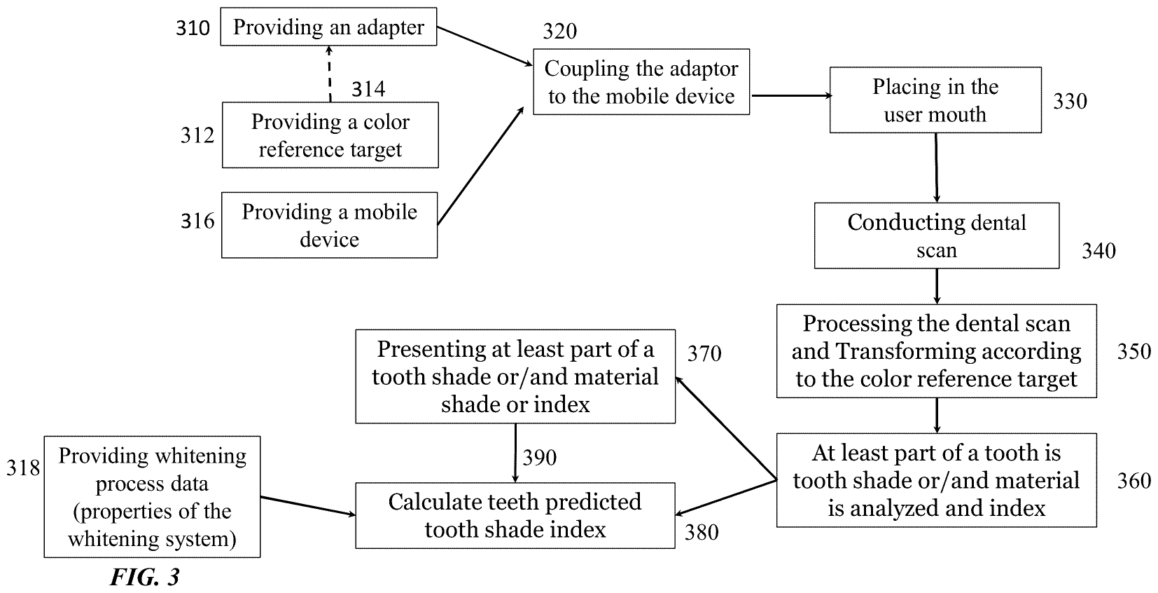

FIG. 3 illustrates a method for assessment or monitor teeth whitening process. First, an intraoral adapter 310, a color reference target 312, and a mobile device 316 may be provided to a user. The color reference target 312 can be an integrated part of adapter 310, or in some cases the user can attached or insert 314 the color reference target 312 into the adapter 310. Next, the user may couple 320 the mobile device 316 to the adapter 310. Next, the user may use the mobile device 316 to initiate a dental scan 340 after placing the adapter in his mouth 330. The dental scan (e.g., videos or images) 350 may be process and transform in the mobile devise according to the color reference target 350. Next at least part of a tooth is tooth shade and/or material analyzed and index 360. The transformed at least part of a tooth is tooth shade or/and material shade or index can be presented 370. In addition a whitening process data can be provided 318 and teeth predicted tooth shade can be calculate 380 and can be presented 390.

In some embodiments, the methods described herein can be used for identifying the color or the shade of at least part of one tooth. In some embodiments the methods describe herein can be used for identifying the color or the shade of the teeth. In some embodiments the methods describe herein can be used for assessing the effectiveness of a whitening process. A plurality of frames from an intraoral video or intraoral images may be captured using a software application. The intraoral videos may comprise partial or full arch movement videos, of which the user moves the head from left to right, right to left, up to down, or down to up. The one or more intraoral videos may be captured while the subject is biting down (i.e., when the subject's upper dental arch and lower dental arch are in contact with or adjacent to each other).

### Computer Systems

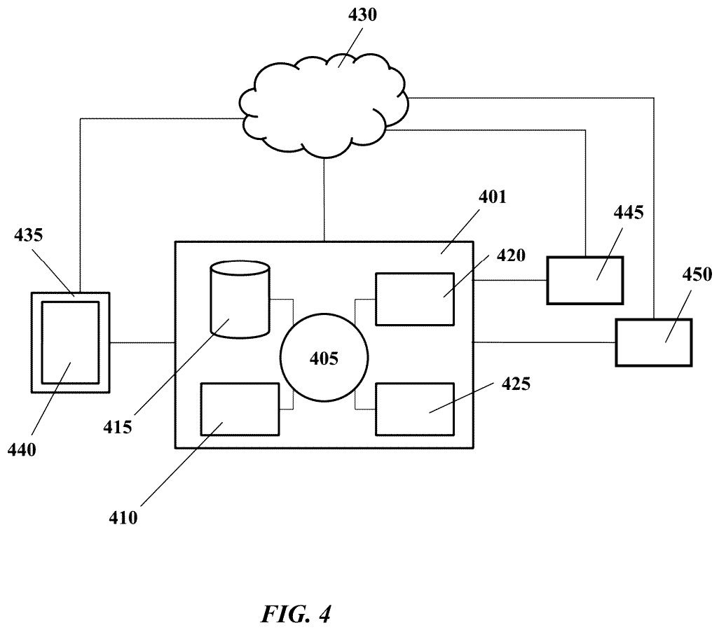

In an aspect, the present disclosure provides computer systems that are programmed or otherwise configured to implement methods of the disclosure. FIG. 4 shows a computer system 401 that is programmed or otherwise configured to implement a method for dental scan. The computer system 401 may be configured to, for example, process intraoral videos or images captured using the camera of the mobile device, and determine at least one of the teeth color or shade during or after the dental scan. The computer system 401 can be an electronic device of a user or a computer system that is remotely located with respect to the electronic device. The electronic device can be a mobile electronic device. The computer system 401 can be a smartphone.

The computer system 401 may include a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk, Solid State drive or equivalent storage unit), communication interface 420 (e.g., network adapter) for communicating with one or more other systems, and peripheral devices 425, such as cache, other memory, data storage and/or electronic display adapters. The memory 410, storage unit 415, interface 420) and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are located external to the computer system 401 (e.g., on a remote server that is in communication with the computer system 401 through an intranet or the Internet).

The computer system 401 can communicate with one or more remote computer systems through the network 430. For instance, the computer system 401 can communicate with a remote computer system of a user (e.g., a subject, a dental user, or a dentist). Examples of remote computer systems include personal computers (e.g., portable PC), slate or tablet PC's (e.g., Apple R: iPad, Samsung R; Galaxy Tab), telephones, Smart phones (e.g., Apple R: iphone, Android-enabled device, Blackberry®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a storage unit. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables: copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a portal for a subject or a dental user to view one or more intraoral images or videos captured using a mobile device of the subject or the dental user. In some cases, the electronic display 435 may be the feedback element providing the generated output, for example displaying message or shape or light in accordance to some embodiments. In some cases, the user interface (UI) 440 may be the feedback element providing the generated output, for example generating sound or voice message in accordance to some embodiments. The portal may be provided through an application programming interface (API). A user or entity can also interact with various elements in the portal via the UI. Examples of UI's include, without limitation, a graphical user interface (GUI) and web-based user interface.

The computer system 401 can include or be in communication with a Camera 445 for providing, for example, ability to capture videos or images of the subject or a dental user. And for example, retrieve at least one dental scan date (such as optical object distance) that can be used to analyzed and compered to at least one dental scan properties

The computer system 401 can include or be in communication with a sensor or Sensors 450 including, but not limited to orientation sensor or motion sensor for providing, for example, orientation sensor data or motion sensor data during the dental scan. And for example, retrieve at least one dental scan date (such as acceleration) that can be used to analyzed and compered to at least one dental scan properties

Methods and systems of the present disclosure can be implemented by way of one or more algorithms. An algorithm can be implemented by way of software upon execution by the central processing unit 405. The algorithm can, for example, implement a method for dental scan. The method may comprise processing videos or images captured using the camera of the mobile device or processing dental scan data sensed by at least one sensor that can be used to analyze and compare to at least one dental scan properties and executed to generate output.

While embodiments have been shown and described herein, it will be obvious to those skilled in the art that such embodiments are provided by way of example only. It is not intended that the systems and methods described herein be limited by the specific examples provided within the specification. While the systems and methods described herein has been described with reference to the aforementioned specification, the descriptions and illustrations of the embodiments herein are not meant to be construed in a limiting sense.

Numerous variations, changes, and substitutions will now occur to those skilled in the art without departing from the systems and methods described herein. Furthermore, it shall be understood that all aspects of the systems and methods described herein are not limited to the specific depictions, configurations or relative proportions set forth herein which depend upon a variety of conditions and variables. It should be understood that various alternatives to the embodiments described herein may be employed in practicing the systems and methods described herein. It is therefore contemplated that the systems and methods described herein shall also cover any such alternatives, modifications, variations or equivalents. It is intended that the following claims define the scope of the systems and methods described herein and that methods and structures within the scope of these claims and their equivalents be covered thereby.

What is claimed is:

1. A method to monitor progress or predict an outcome of a tooth whitening regimen, comprising:
(a) providing an adapter comprising a viewing channel configured to define a field of view of an intraoral region of a subject's mouth, wherein one or more teeth are visible in the field of view of the subject's mouth;
(b) providing a color reference target comprising one or more color samples, wherein the color reference target appears in the field of view of the subject's mouth, and wherein each of the one or more color samples is associated with a reference color or shade;
(c) using the color reference target to identify the color or shade of the one or more teeth; and
(d) predicting the outcome of the tooth whitening regimen based on the identified color or shade of the one or more teeth and, optionally, one or more properties of the one or more teeth.

2. The method of claim 1, wherein the adapter comprises a flange that is configured to couple the adapter to the subject's mouth.

3. The method of claim 1, wherein the adapter is configured to block environment light from the field of view of the intraoral region of the subject's mouth.

4. The method of claim 1, wherein the adapter is configured to couple to a camera configured to capture images or videos of the subject's mouth, wherein the captured images or videos comprise the one or more teeth of the subject.

5. The method of claim 1, wherein the adapter is configured to be moved in the subject's mouth to adjust the field of view of the intraoral region of the subject's mouth.

6. The method of claim 1, wherein the one or more color samples are based on a color quantification scheme.

7. The method of claim 6, wherein the color quantification scheme is the Munsell color system.

8. The method of claim 1, wherein at least one of the one or more color samples is chosen from a color in a ColorChecker calibration target.

9. The method of claim 1, wherein at least one of the one or more color samples is a color of a natural tooth.

10. The method of claim 1, wherein at least one of the one or more color samples is a shade of a natural tooth under light at a wavelength of 390 nm to 450 nm.

11. The method of claim 1, wherein at least one of the one or more color samples is a shade of a natural tooth under fluorescent light.

12. The method of claim 1, wherein a processing unit is used to identify the color or shade of the one or more teeth, and wherein a mobile device comprises the processing unit.

13. The method of claim 4, wherein identifying the color or shade of the one or more teeth comprises using the reference color or shade of the one or more color samples to identify the color of the one or more teeth in the captured videos or images.

14. The method of claim 1, wherein a property of the one or more visual properties comprises a reflection of light from the one or more teeth.

15. The method of claim 1, wherein a property of the one or more properties comprises an opacity of the one or more teeth.

16. The method of claim 1, wherein a property of the one or more properties comprises a thickness of the dentin of the one or more teeth.

17. The method of claim 1, wherein a property of the one or more properties comprises a classification of the tooth as natural or artificial.

18. The method of claim 1, wherein the color or shade of the one or more teeth is the color or shade of the one or more teeth prior to the subject undergoing the tooth whitening treatment.

19. The method of claim 1, wherein the predicted outcome comprises a predicted color or shade of the one or more teeth subsequent to the tooth whitening regimen.

20. A kit for monitoring progress or predicting an outcome of a tooth whitening regimen, comprising:
(a) an adapter comprising a viewing channel configured to define a field of view of an intraoral region of a subject's mouth, wherein one or more teeth are visible in the field of view of the subject's mouth;
(b) a color reference target comprising one or more color samples, wherein the color reference target appears in the field of view of the subject's mouth, and wherein each of the one or more color samples is associated with a reference color or shade; and
(c) a mobile application configured to use the color reference target to identify the color or shade of the one or more teeth and predict the outcome of the tooth whitening regimen based on the identified color or shade of the one or more teeth and, optionally, one or more properties of the one or more teeth.
